(19) United States
(12) Patent Application Publication
(10) Pub. No.: US 2016/0149229 A1
(43) Pub. Date: May 26, 2016

(54) Novel Non-Platinum Metal Catalyst Material

(71) Applicant: TECHNICAL UNIVERSITY OF DENMARK, Kgs. Lyngby (DK)

(72) Inventors: Qingfeng LI, Brøndby Strand (DK); Jens Oluf JENSEN, Valby (DK); Yang HU, Lyngby (DK); Niels J. BJERRUM, Charlottenlund (DK)

(73) Assignee: Technical Universit of Denmark, 2800 Kgs. Lyngby (DK)

(21) Appl. No.: 14/899,392

(22) PCT Filed: Jun. 20, 2014
(86) PCT No.: PCT/EP2014/063009

§ 371 Date: Dec. 17, 2015

(30) Foreign Application Priority Data
Jun. 21, 2013 (EP) 13173167.1

(51) Int. Cl. H01M 4/90; C25B 11/04

(52) U.S. Cl. CPC H01M 4/9083; C25B 11/0478

(57) ABSTRACT

The present invention relates to a novel non-platinum metal catalyst material for use in low temperature fuel cells and electrolysers and to fuel cells and electrolysers comprising the novel non-platinum metal catalyst material. The present invention also relates to a novel method for synthesizing the novel non-platinum metal catalyst material.

### CROSS-REFERENCE TO RELATED APPLICATION

This application is a national phase entry of pending International Application No. PCT/EP2014/063009, filed Jun. 20, 2014 and titled “Novel Non-Platinum Metal Catalyst Material,” which claims priority to and the benefit of European Patent Application No.: 13173167.1, filed Jun. 21, 2013 and titled “Novel Non-Platinum Metal Catalyst Material.” The contents of the above-identified Applications are relied upon and incorporated herein by reference in their entirety.

### FIELD OF INVENTION

The present invention relates to a novel non-platinum metal catalyst material for use in low temperature fuel cells and electrolysers and to fuel cells and electrolysers comprising the novel non-platinum metal catalyst material. The present invention also relates to a novel method for synthesizing the novel non-platinum metal catalyst material.

### BACKGROUND OF INVENTION

Low temperature fuel cells and water electrolysers are recognized as one of the most promising solutions and strategic approaches for future energy systems based on renewable energy sources. The fuel cells have unique and favourable advantages for applications in transportation, stationary, portable and micropower systems. One key bottleneck to reach commercial viability is the sufficiently active and prohibitively high cost catalysts, which are currently based on noble (platinum) metals as nanoparticles supported on high surface area carbon black. For electrolysers iridium dioxide based noble catalysts are used instead. Further reduction of the cost is a must for the technology to penetrate the market. A significant fraction of the cost is from noble metal catalysts. The catalysts count for approximately 30% of the key cell component for hydrogen fuelled cells while up to 60% for direct methanol fuel cells.

Consequently, there is an increasing interest to replace platinum (Pt) based catalysts with cost-effective non-noble catalysts for the oxygen reduction reaction (ORR) in low temperature cells, such as polymer electrolyte fuel cells (PEFCs) and direct methanol fuel cells (DMFCs) and the like. Owing to the harsh reaction conditions, however, with decades of intense research it is still challenging to find classes of materials that are active and stable for ORR, especially in acid media.

Non-platinum metal catalysts (NPMC) as an alternative could be promising candidates for replacing Pt based catalyst metals for ORR and worldwide efforts are currently devoted to development of NPMCs. Early work examined pyrolysis of transition metal-containing macrocycles resulting in ORR catalysts with promising yet insufficient activity and durability. Later studies aimed at replacing the expensive macrocycle precursors with a wide variety of common nitrogen-containing chemicals (ammonia, acetonitrile, acetates etc.), transition metal inorganic salts (sulfates, nitrates, acetates, hydroxides and chlorides), and carbon supports. From these studies, it was learned that the heat treatment of mixtures of (1) nitrogen, (2) carbon, and (3) metal precursors will result in a material that is ORR active; however, the degree of activity and durability depend greatly on the selection of precursors and synthetic methods.

However, a need still exists for development of alternative NPMCs having improved catalytic activity towards the ORR and possessing increased stability and durability especially when being placed in acidic environment.

The inventors of the present invention have developed a novel method for synthesising a novel type of NPMC. The NPMC comprises structured carbon wrapped metal carbide particles forming spheric clusters, where structured graphitic carbon is monolayer or few-layer graphene or/and nanotubes with high electrical conductivity and chemical stability are structured in a sphere, i.e. thereby forming a spheric cluster. The synthesis is done by a simple one-step method, which is a high-temperature and high-pressure process using simple small molecule precursors as starting material. The structured carbon is in form of either graphene or carbon nanotubes tuneable by varying synthetic parameters. Both the structured carbon and metal carbide particles are produced in this one-step method and the nanoscale structure is self-assembled during the synthesis. The NPMC possess a unique structure of curved graphene sheets and/or carbon nanotubes forming spheres in which the metal carbide particles are uniformly dispersed and intercalated between the interlamellar carbon layers, i.e. corresponding to a spheric cluster comprising the carbon wrapped metal carbide particles. Surprisingly it has been found that this unique structure gives the materials a superior activity towards the ORR and excellent stability when compared with commercially available platinum catalysts.

### SUMMARY OF INVENTION

In a first aspect the present invention is directed to a novel non-platinum metal material, which comprises metal carbide particles and carbon spheres, wherein the metal carbide particles are encapsulated inside of said carbon spheres. The carbon spheres comprise graphene sheets and/or nanotubes, and the metal carbide particles are typically sized as nanoparticles. The graphene sheets may be curved.

In a second aspect the present invention is directed towards the use of the non-platinum material of the present invention as a catalyst.

In another aspect, the present invention is directed to a spheric structure comprising multiple carbon wrapped metal carbide particles uniformly dispersed in the spheric structure, thereby forming a spheric cluster.

In a further aspect the present invention relates to a fuel cell comprising said novel non-platinum metal catalyst material. Typically the cathode of the fuel cell comprises said novel non-platinum metal catalyst, which catalyzes the ORR taking place at the surface of the cathode.

In yet an aspect the present invention relates to an electrolyser comprising said novel non-platinum metal catalyst material. Typically the anode of the electrolyser comprises said novel non-platinum metal catalyst, which catalyzes the oxygen evolution reaction taking place at the surface of the anode.

In a further aspect the present invention is directed to a novel method for preparing the novel non-platinum metal catalyst material.

### DESCRIPTION OF DRAWINGS

FIG. 1 shows TEM images of samples from Examples 1 (c), 2 (a), 3(b), 5(d) and 6 (e: Fe₃C/C-1/0-700 and f Fe₃C/C-1/1-700). The images illustrate catalyst spheres of a solid (Example 2), porous (Example 3) and hollow (Example 1) structure comprising carbon nanotubes and wrapped carbide particles. FIG. 1(d) is the catalyst sphere consisting of curved graphene sheets with intercalated carbide particles, while Figures (e and f) shows no spherical morphologies due to the mismatching of precursor stoichiometries.

FIG. 2 shows XRD patterns of samples from Examples 1 (700° C.), 2(500° C.), 3(600° C.), and 4(800° C.). It is seen that the spheres formed at 500° C. comprises melamine crystallines, the spheres obtained at 600° C. comprise little carbide phase while those synthesized at 700 and 800° C. show diffraction patterns of the carbides.

FIG. 3 shows rotating disk electrode polarization curves of samples from Example 1 (700° C.), 2(500° C.), 3(600° C.), 4(800° C.) ,5(graphene-based sample) and commercial Pt/C catalyst (20 wt % Pt/C) . The electrolyte was O₂-saturated 0.1 M HClO₄ at room temperature. The rotating speed was 900 rpm and the scan rate was 10 mv s⁻¹. It is seen that the sample at 500° C. shows little activity and that of the sample at 600° C. improves, while those of the samples synthesized at 700 and 800° C. are close to that of the platinum analogue. In addition the graphene wrapped carbide catalyst is just as good as those of carbon nanotubes.

FIG. 4 shows rotating disk electrode polarization curves of samples from Example 1 (700° C.), 2(500° C.), 3(600° C.), 4(800° C.), 5(graphene-based sample) and commercial Pt/C catalyst (20 wt % Pt/C). The electrolyte was O₂-saturated 0.1 M KOH at room temperature. The rotating speed was 900 rpm and the scan rate was 10 mv s⁻¹. It is seen that the sample obtained at 500° C. shows little activity and that of the sample at 600° C. improves. The other three samples synthesized at 700 and 800° C., with either graphene and carbon nanotubes behave as well as the commercial platinum catalyst.

FIG. 5 shows rotating disk electrode polarization curves of samples from Example 7(Ni-based) and 8 (Co-based), Example 4 (Fe-based) and commercial Pt/C catalyst (20 wt % Pt/C). The electrolyte was O₂-saturated 0.1 M HClO₄ at room temperature. The rotating speed was 900 rpm and the scan rate was 10 mv s⁻¹. It is seen that the catalysts containing nickel and cobalt showed significant activity though slightly lower than that of iron.

FIG. 6 shows rotating disk electrode polarization curves of samples from Example 7(Ni-based) and 8 (Co-based), Example 4 (Fe-based) and commercial Pt/C catalyst (20 wt % Pt/C). The electrolyte was O₂-saturated 0.1 M KOH at room temperature. The rotating speed was 900 rpm and the scan rate was 10 mv s⁻¹. It is seen that the catalysts containing nickel and cobalt showed significant activity though slightly lower than that of iron.

FIG. 7a shows scanning electronic microscopic image of the sample from Example 9, which was the sample of Example 4 subject to ball-milling and acid leaching. FIG. 7b is the photograph showing the magnetic property of the sample from Example 4 and FIG. 7c shows the magnetic property of the sample from Example 9 after acid leaching process. In FIG. 7d, however, the magnetic property of the sample from Example 9 after ball milling and acid leaching disappears. This illustrates the fact that the destruction of the carbon wrapping carbide structure, after the ball-milling, exposes the carbide nanoparticles to the acid leaching and therefore subject to the carbide dissolution and catalytic inactivity.

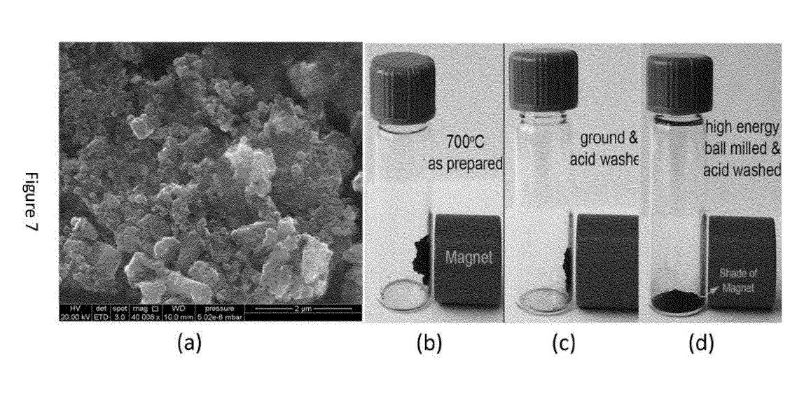

### DETAILED DESCRIPTION OF THE INVENTION

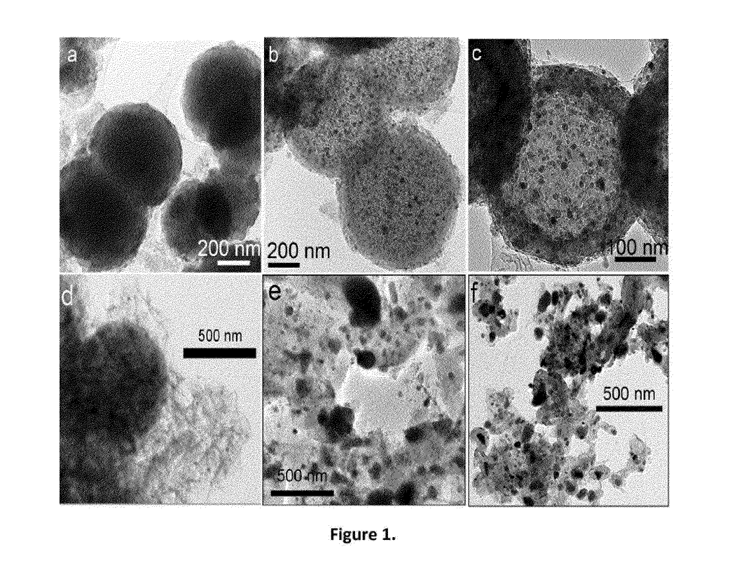

The present invention is directed to a non-platinum metal catalyst material comprising metal carbide particles and carbon spheres, wherein the metal carbide particles are encapsulated inside of said carbon spheres in such a way that the particles are completely isolated by the carbon layers. The encapsulated metal carbide particles may further be uniformly dispersed in a spheric structure, i.e. a spheric cluster. In some embodiments the further structured spheres are hollow with carbon crust surroundings. An example of such a structure is illustrated in FIG. 1c. In some embodiments the further structured spheres are porous. FIG. 1b is an example of such a porous sphere. In some embodiments the structured spheres are solid. An illustration of the solid sphere is given in FIG. 1a.

It is an object of the present invention that any of the embodiments of the non-platinum metal materials disclosed herein are used as a catalyst.

In some embodiments the carbon spheres comprise curved graphene sheets and/or nanotubes. In other embodiments the carbon spheres essentially consist of curved graphene sheets and/or nanotubes.

By the term “graphene” as used herein is meant a material in which carbon atoms are arranged in a regular hexagonal pattern. Graphene can be described as a one-atom thick layer of the mineral graphite. Many layers of graphene stacked together effectively form crystalline flake graphite. Hence, graphene is a flat monolayer of carbon atoms tightly packed into a two-dimensional (2D) honeycomb lattice, and is a basic building block for graphitic materials of all other dimensionalities. It can be wrapped up into 0D fullerenes, rolled into 1D nanotubes or stacked into 3D graphite. The crystalline or “flake” form of graphite consists of many graphene sheets stacked together.

In some embodiments of the present invention the carbon layers are formed as curved sheets and/or nanotubes so that a spherical shell is formed surrounding the metal carbide particles in such a way that the particles are completely isolated by the carbon layers. This unique structure is meant to be the key feature as to why the novel catalyst material possesses superior chemical stability because dissolution of the carbides is avoided when the graphene sheets and nanotubes are protecting the metal carbide particles from coming in contact with either acid or alkaline in the fuel cell during the ORR.

In some embodiments of the present invention, the encapsulating carbon shell comprises an unbroken carbon layer, i.e. the graphene sheets and/or nanotubes are continuous without a defined edge, similar to an onion layer. In some embodiments of the present invention, the encapsulating carbon layer comprises broken or discontinuous graphene sheets and/or nanotubes. The broken layers thus form flakes or fragments that are structured to surround the metal catalyst, and thereby encapsulating said metal catalyst.

An interesting feature that distinguishes the structure of the catalyst material of the present invention from the structure of known NPMCs is that no additional carbon substrate is necessary for producing the novel NPMC of the present invention. In contrary, most NPMC synthesis is based on iron-carbon-nitrogen (Fe—C—N) composites and use carbon substrates or supports as the starting materials. Thus obtained are catalysts “supported” on the previously structure-defined substrates. The catalyst material of the present invention is typically started from precursors with no support. The entire nano-structures of the final product are formed during the synthesis.

Different types of metal carbide particles may be formed depending on the type of precursors used as starting materials. In some embodiments the metal carbide particles are transition metal carbides, where the transition metal is selected from the group consisting of iron, nickel, cobalt, chromium, titanium, copper and manganese. In a preferred embodiment the metal carbide particles are transition metal carbides, where the transition metal is selected from the group consisting of iron, nickel and cobalt. In some embodiments the transition metal is a ferromagnetic element, such as iron, nickel, cobalt and their alloys. In other embodiments the metal carbides are mixtures of two, three or more transition metal carbides, where the transition metal is selected from the group consisting of iron, nickel, cobalt, chromium, titanium, copper and manganese.

The metal carbide particles may be present in different sizes. In some embodiments, however, the metal carbide particles are present as nanoparticles having a size in the range of up to 50 nm, more preferred in the range of from 2-20 nm, such as for example 3-12 nm. The second spheric structure is in the microrange, preferably having a size in the sub micro range of smaller than 1000 nm. For example the size may be smaller than 750 nm, such as a size between 250 nm and 750 nm.

The main component of the novel catalyst material is carbon. Typically the carbon content lies in the range of 50-95 wt%, such as for example from 80-85 wt %. The other major component is the metal forming part of the metal carbide. Typically the metal content lies in the range of 5-50 wt %, such as for example in the range of from 10-20 wt %. Traces of nitrogen, such as for example less than 2 wt %, may typically also be present, which is, however, not considered necessary for the performance of the materials. In embodiments where the metal carbide is iron carbide the content of carbon, iron and nitrogen is typically 80-85 wt % carbon, 10-15 wt % iron, 1-2 wt % nitrogen. Of course, small amounts of oxygen may be present, most likely from the storage in atmosphere.

The present invention is also directed to a fuel cell, in which at least one of the electrodes comprises the novel non-platinum metal catalyst material. In some embodiments it is the cathode in the fuel cell that comprises the non-platinum metal catalyst material. In the fuel cell it is on the surface of the cathode that the ORR occurs. In some types of fuel cells this reaction takes place in alkaline media, whereas in other types of fuel cells the ORR takes place in acidic media. It has been found that the novel catalyst material of the present invention shows excellent activity and stability for the ORR. Moreover, the novel catalyst material also shows good selectivity towards the 4 electron ORR, where oxygen is converted into water as compared with the 2 electron reaction, where oxygen is converted into hydrogen peroxide.

The present invention is also directed to an electrolyser, wherein at least one of the electrodes comprises the novel non-platinum metal catalyst material. In some embodiments it is the anode in the electrolyser that comprises the novel non-platinum metal catalyst material. In the electrolyser it is on the surface of the anode that the oxygen evolution reaction takes place.

The present invention is also directed to a novel method for preparing a non-platinum metal catalyst material. In its broadest aspect this method comprises the steps of:
(i) providing a carbon precursor
(ii) providing a metal precursor,
(iii) introducing the carbon precursor and the metal precursor into an autoclave, and
(iv) dry-autoclaving the mixture of metal precursor and carbon precursor at high temperatures with auto-generated pressure under an inert atmosphere.

It is a major advantage of this method, as compared with known methods, that the method is a one-step method, because it makes it simple and cheap to prepare the novel catalyst material.

In an embodiment the present invention relates to the product obtained by the method comprising the steps of:
(i) providing a carbon precursor,
(ii) providing a metal precursor,
(iii) introducing the carbon precursor and the metal precursor into an autoclave, and
(iv) dry-autoclaving the mixture of metal precursor and carbon precursor at high temperatures with auto-generated pressures under an inert atmosphere.

In some embodiments the precursors are small and volatile molecules. The term “small molecule” as used herein is meant molecules that are not polymers, and by the term “volatile molecule” as used herein is meant molecules that become volatile during the dry-autoclaving. This seems to be important for the carbon structure development and metal functionality deposition in a single step. The nature of the autoclaving process makes it possible to use novel volatile precursors that are not adaptable for other zo processes with no pressurization. The co-formation of carbon and metal functionalities allows for self-assembling of materials in nanostructures. It lies within the skills of an ordinary practitioner to understand, which molecules that qualify as small and volatile as defined herein.

In some embodiments the carbon precursor comprises one or more nitrogen atoms, which possess capability to form complexes with the metal species. It is believed that the complexes are formed in the spherical structures and the structures serve as a template for the development of the catalyst materials. It is believed that it is in the formed spherical template that the metal species are uniformly dispersed. Up on further autoclaving the metal species catalyze the growth of the graphene sheets and/or carbon nanotubes. It is also due to the spherical template that the metal species are confined with little mobility and therefore permit for co-formation of structured carbon and the netal functionalities. Examples of carbon precursors include one or more heterocyclic molecules, preferably selected from the group consisting of cyanamide, cyanides, cyanuric acid, uric acid, imidazole, benzimidazole and amino-substituted triazines like ammeline, ammelide and melamine. Cyanamide is the preferred carbon precursor.

In some embodiments the metal precursor is one or more organometallic compounds, where the metal preferably is selected from the group consisting of iron, nickel, cobalt, titanium, copper and manganese. In a preferred embodiment the metal is selected from the group consisting of iron, nickel and cobalt. Those metal compounds that contain an oxygen atom, such as for example, acetates or sulphates, are not preferred as they are introducing oxygen into the autoclaves. Examples of preferred metal precursors include ferrocene, nickelocene and cobaltocene.

In some embodiments the carbon precursor is ferrocene and the metal precursor is selected from the group consisting of ferrocene, nickelocene and cobaltocene. In a particular embodiment, the carbon precursor is cyanamide and the metal precursor is ferrocene, whereby nanoparticles made of iron carbide are formed. The molar ratio between the carbon precursor and the metal precursor may be 1:1, preferably the molar ratio of the carbon precursor to the metal precursor is more than 1:1, such as 2:1 such as 3:1, such as 10:1, 20:1 or 30:1 and so on. Most preferably the molar ratio of the carbon precursor to the metal precursor is 40:1.

The dry-autoclaving step proceeds at a high temperature with auto-generated pressures under an inert atmosphere. As used herein the term “auto-generated pressure” is meant that it is the temperature that regulates the dry-autoclaving step and the resulting (or auto-generated) pressure is simply just monitored. A skilled person would know that this auto-generated pressure will depend on several factors such as for examples the temperature and the type and amount of precursors. Typically, the dry-autoclaving step proceeds at a temperature lying in the range of 500-1100° C. In a particular embodiment the carbon precursor is cyanamide and the metal precursor is ferrocene and the dry-autoclaving step proceeds at a temperature ranging from 600-800° C., such as for example 700° C., such as for example 800° C. Thus the method may be performed in a temperature interval between 650° C. and 850° C. The dry-autoclaving step may typically proceed at any pressure lying in the range of 200-800 bars.

It is essential that the dry-autoclaving step proceeds under an inert atmosphere in order to avoid any formation of metal oxides. By the term “inert atmosphere” as used herein is meant oxygen-free atmosphere, such as for example a N₂ atmosphere. A skilled person will know how to perform such step under inert atmosphere.

### EXAMPLES

### Electrochemical Evaluation

Electrochemical measurements were conducted using Versa STAT3 electrochemical system (Princeton Applied Research). Fe₃C/C—S catalyst ink was prepared by ultrasonically dispersing 10 mg of Fe₃C/C—S in a mixture solution containing 80 μL Nafion (5 wt. %) solution and 514 μL ethanol, while JM PVC catalyst (20 wt % Pt on Vulcan XC72R carbon, Johnson Matthey) ink was prepared by dispersing 5 mg of Pt/C catalyst ultrasonically in a mixture solution containing 50 μL Nafion (5 wt %) solution, 600 μL ethanol and 400 μL Milli-Q water. The catalyst film coated electrode was obtained by dispersing the catalyst ink on a glassy carbon rotating disk electrode (RDE) followed by drying in air. The catalyst loading on RDE was 0.6 mg cm⁻² for Fe₃C/C—S catalyst and 50 μg (Pt) cm⁻² for Pt/C catalyst. A conventional three-electrode cell was employed incorporating a saturated calomel electrode (SCE) as the reference electrode, a Pt wire as the counter electrode and the catalyst film coated RDE as the working electrode. The electrolyte was 0.1 M HClO4 solution or 0.1 M KOH solution. RDE measurements were conducted by liner sweep voltammetry (LSV) from 1.1 V to 0.2 V at different rotating speeds from 500 to 2500 rpm. All the ORR currents presented in the figures are Faradaic currents, i.e., after correction for the capacitive current. In all figures, the potentials were converted to values versus the reversible hydrogen electrode (RHE). All experiments were carried out at 25° C. in a thermostatic bath.

### Example 1

### Synthesis of Fe₃C/C—S-700 Catalyst

In this and all following examples, an autoclave was assembled from home-made stainless steel parts with Swagelok-like structure. A ½″ union part was plugged on both sides by two stoppers. A specially designed quartz cup was placed in the autoclave, after which the precursors were inserted. The precursors of 0.467 g cyanamide (CN₂H₂) and 0.052 g ferrocene (Fe(C₅H₅)₂) corresponding to a molar ratio of nearly 40:1 were mixed and introduced into the autoclave (ca. 3.3 mL) at room temperature in a nitrogen-filled glove box. The autoclave was closed tightly and placed at the centre of a tube-furnace under a N₂ flow to protect the outside surface of the autoclave at high temperature. The temperature of the furnace was raised to 700° C. at a rate of 10° C./min and maintained at that temperature for 3 hours. By assuming decomposition of the precursors into simple gaseous molecules like N₂ and CHₓ, the pressure inside the autoclave would be above 6.0×10⁷ Pa at this temperature. Then it was gradually cooled to room temperature and opened. A black soft powder with a ca. 28% weight relative the total weight of precursors was obtained.

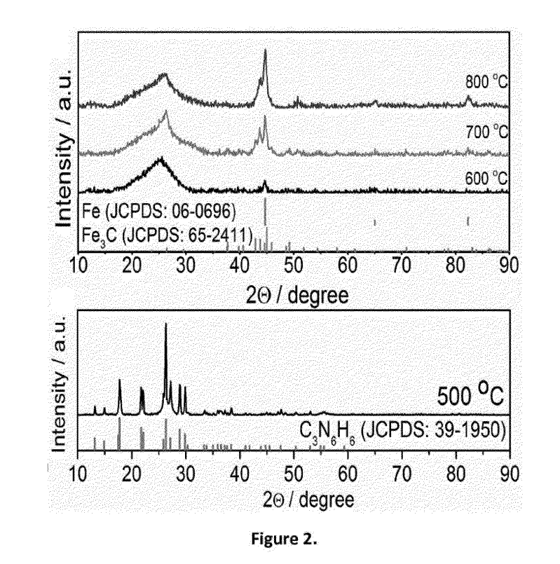

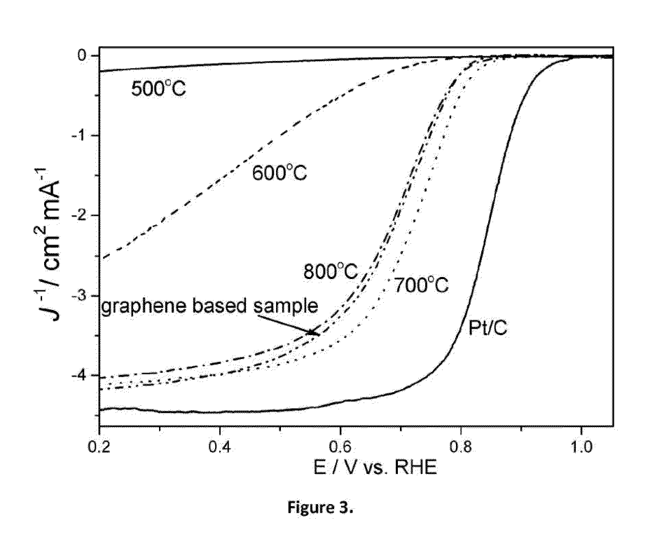

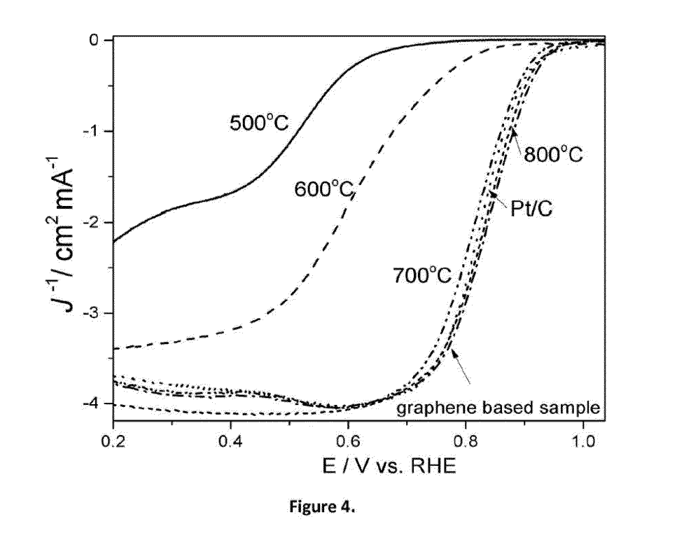

The powder had a porous sphere morphology as shown in FIG. 1c. The spheres were hollow in structure and the outer crust consists of carbon nanotubes of 5-15 nm. Inside the nanotubes were decorated with carbide nanoparticles of less than 10 nm size. The XRD pattern showed the broad peaks at ca. 26.5° corresponding to the (002) planes of carbon phase (FIG. 2). The sharp diffraction peaks around 45° were of characteristics of the crystalline planes of Fe₃C with trace of metallic iron phase, which were further confirmed by the HRTEM and SAED analysis. The bulk element composition of the sample was analyzed with the Energy Dispersive X-ray spectroscopy (EDX) and CHN measurement, showing an elemental composition of ca. 83.3 wt % C and 12.8 wt % Fe, a small amount of nitrogen (1.1 wt % N) and ca. 2.8 wt % O. Electrochemical evaluation of the sample in both acidic (0.1 M HClO4, FIG. 3) and alkaline (0.1 M KOH, FIG. 4) showed excellent activity towards the oxygen reduction reactions.

### Example 2

### Synthesis of Fe₃C/C-40/1-500 Catalyst

The same autoclave assembly as described in Example 1 was used. The precursors of 0.467 g cyanamide (CN₂H₂) and 0.052 g ferrocene (Fe(C₅H₅)₂) corresponding to a molar ratio of nearly 40:1 were mixed and introduced into the autoclave (ca. 3.3 mL) at room temperature in a nitrogen-filled glove box. The autoclave was closed tightly and placed at the centre of a tube-furnace under a N₂ flow to protect the outside surface of the autoclave at high temperature. The temperature of the furnace was raised to 500° C. zo at a rate of 10° C./min and maintained at that temperature for 3 hours. Then it was gradually cooled to room temperature and opened.

The powder had a sphere morphology as shown in FIG. 1a. The spheres were however solid. XRD showed clear crystallines of melamine, which was apparently formed from polymerization of the cyanamide. The metal species was well dispersed in the spherical structure, however, no metal carbide is formed at all in this low temperature range. The sample illustrated the formation of the spherical template at 500° C., whose structure was clearly preserved in samples obtained in Example 1. The obtained sample powder showed little electrochemical activity for ORR in acidic (FIG. 3) or alkaline (FIG. 4) media.

### Example 3

### Synthesis of Fe₃C/C-40/1-600 Catalyst

The same autoclave assembly as described in Example 1 was used. The precursors of 0.467 g cyanamide (CN₂H₂) and 0.052 g ferrocene (Fe(C₅H₅)₂) corresponding to a molar ratio of nearly 40:1 were mixed and introduced into the autoclave (ca. 3.3 mL) at room temperature in a nitrogen-filled glove box. The autoclave was closed tightly and placed at the centre of a tube-furnace under a N₂ flow to protect the outside surface of the autoclave at high temperature. The temperature of the furnace was raised to 600° C. at a rate of 10° C./min and maintained at that temperature for 3 hours.

The powder had a porous sphere morphology as shown in FIG. 1b. The spheres appeared porous, with formation of uniformly dispersed metal carbide particles. The particle size was in a range of less than 20 nm. The carbon phase is primarily in form of nanotubes. The XRD pattern showed a small peak (FIG. 2) characteristic of the crystalline metal carbide. Further analysis by the HRTEM and SAED analysis showed nearly no presence of the metal. Electrochemical evaluation of the sample in both acidic (0.1 M HClO4, FIG. 3) and alkaline (0.1 M KOH, FIG. 4) showed increased activity as compared with Example 2 however much poorer than that of Example 1.

### Example 4

### Synthesis of Fe₃C/C-40/1-800 Catalyst

The same autoclave assembly as described in Example 1 was used. The precursors of 0.467 g cyanamide (CN₂H₂) and 0.052 g ferrocene (Fe(C₅H₅)₂) corresponding to a molar ratio of nearly 40:1 were mixed and introduced into the autoclave (ca. 3.3 mL) at room temperature in a nitrogen-filled glove box. The autoclave was closed tightly and placed at the centre of a tube-furnace under a N₂ flow to protect the outside surface of the autoclave at high temperature. The temperature of the furnace was raised to 800° C. at a rate of 10° C./min and maintained at that temperature for 3 hours.

The powder had a very porous sphere morphology, very much similar to that of Example 1. No tracers of nitrogen or iron were identified on the surface of the powder. The carbon phase is primarily in form of nanotubes. Electrochemical evaluation of the sample in acidic (0.1 M HClO4, FIG. 3) electrolyte showed slightly lower activity that that for Example 1. In alkaline (0.1 M KOH, FIG. 4) electrolyte, however, the catalytic activity is just as good as or in fact slightly better than that of Example 1.

### Example 5

### Synthesis of Fe₃C/C-40/1-½P-700 Catalyst

The same autoclave assembly as described in Example 1 was used. The precursors of 0.467 g cyanamide (CN₂H₂) and 0.052 g ferrocene (Fe(C₅H₅)₂) corresponding to a molar ratio of 40:1 and introduced into the autoclave (ca. 3.3 mL) at room temperature in a nitrogen-filled glove box. The autoclave was closed tightly and placed at the centre of a tube-furnace under a N₂ flow to protect the outside surface of the autoclave at high temperature. The temperature of the furnace was raised to 800° C. at a rate of 10° C./min and maintained at that temperature for 3 hours. During the synthesis a release of about half of the chemical charge in the autoclave occurred so that the total yield of the catalyst materials was about 60% of that of Example 1.

Thus obtained powder had a porous sphere morphology as shown in FIG. 1d. The spheres were hollow in structure. A closer view of the carbon clusters revealed that the carbon in fact was in forms of graphene slides. As examined by atomic force microscopy (AFM) the thickness of these graphene sheets was less than 1 nm, consistent with that of the single-layer graphene (0.6-1.0 nm by AFM) reported in literatures. Metal carbide nanoparticles were uniformly dispersed between the interlamilar space of the graphene sheets. Electrochemical evaluation of the sample in both acidic (0.1 M HClO4, FIG. 3) and alkaline (0.1 M KOH, FIG. 4) showed excellent activity towards the oxygen reduction reactions.

### Example 6

### Synthesis of Fe₃C/C-1/1-700 Catalyst and Fe₃C/C-1/0-700 Catalyst

The same autoclave assembly as described in Example 1 was used. In the first part of this Example, pure ferrocene was used with no inclusion of any nitrogen containing carbon precursor. The second part of this Example, a molar ratio of cyanamide to ferrocene increased to 1:1. The synthetic procedure was the same as Example 4, as described above at 800° C.

When pure ferrocene was used as the precursor, the product was only big Fe particles as large as ca. 400 nm wrapped in thick carbon shells without notable morphology (FIG. 1e).

When the molar ratio of cyanamide to ferrocene increased to 1:1, Fe₃C phase began to appear. The Fe-rich particles became smaller while the carbon shell was thinner but also in a randomly shape (FIG. 1f). Both samples show poor ORR activity.

### Example 7

### Synthesis of NiC/C-40/1-800 Catalyst

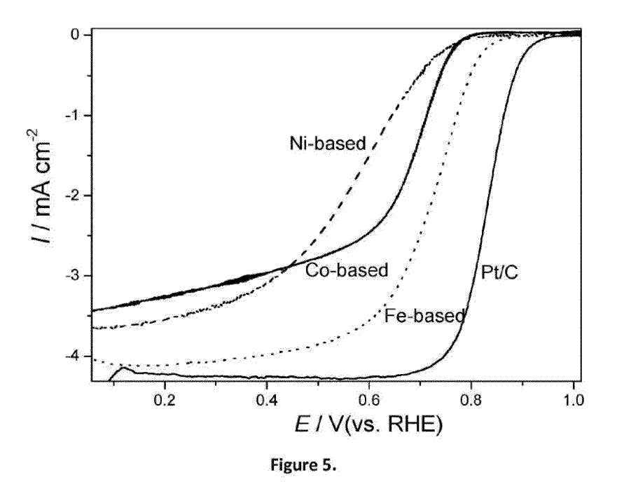

The same autoclave assembly as described in Example 1 was used. The precursors, cyanamide (CN₂H₂) and nickelocene (Ni(C₅H₅)₂) were mixed in a molar ratio of 40:1 and introduced into the autoclave (ca. 3.3 mL) at room temperature in a nitrogen-filled glove box. The autoclave was closed tightly and placed at the centre of a tube-furnace under a N₂ flow to protect the outside surface of the autoclave at high temperature. The temperature of the furnace was raised to 800° C. at a rate of 10° C./min and maintained at that temperature for 3 hours. Then it was gradually cooled to room temperature and opened. The obtained sample appeared similar to Example 4 that the carbon phase was consisting of carbon nanotubes in which the metal carbide nanoparticles were located with good dispersion. Electrochemical evaluation of the sample in both acidic (0.1 M HClO4, FIG. 3) and alkaline (0.1 M KOH, FIG. 4) showed good activity however lower than that of Example 4 (FIG. 5).

### Example 8

### Synthesis of CoC/C-40/1-800 Catalyst

The same autoclave assembly as described in Example 1 was used. The precursors, cyanamide (CN₂H₂) and cobaltocene (Co(C₅H₅)₂) were mixed in a molar ratio of 40:1 and introduced into the autoclave (ca. 3.3 mL) at room temperature in a nitrogen-filled glove box. The autoclave was closed tightly and placed at the centre of a tube-furnace under a N₂ flow to protect the outside surface of the autoclave at high temperature. The temperature of the furnace was raised to 800° C. at a rate of 10° C./min and maintained at that temperature for 3 hours. Then it was gradually cooled to room temperature and opened.

The obtained sample appeared similar to Example 4 that the carbon phase was consisting of carbon nanotubes in which the metal carbide nanoparticles were located with good dispersion. Electrochemical evaluation of the sample in both acidic (0.1 M HClO4) and alkaline (0.1 M KOH) showed good activity however lower than that of Example 4 (FIG. 5).

### Example 9

### Ball Milled Sample of Fe₃C/C-40/1-800-BL

All catalyst samples from the Examples described above were further tested by acid leaching in 0.5 M H₂SO₄ solution at 85° C. for 9 hours. After the leaching test, the metal carbide phase and the electrochemical activity remained.

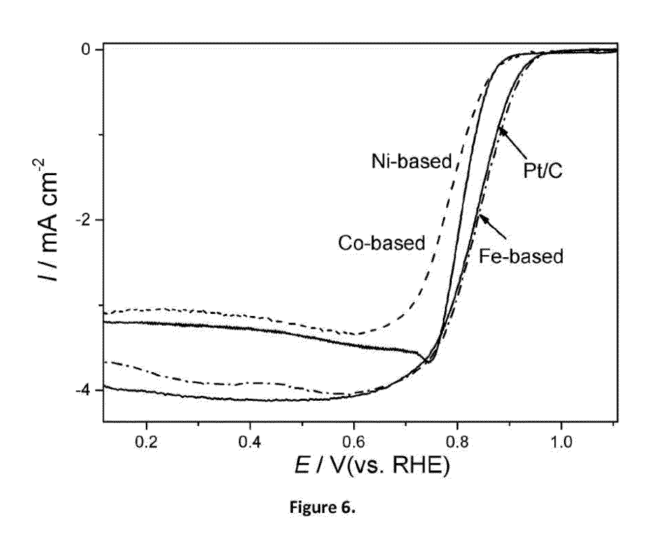

The catalyst sample from Example 4 was further subject to ball milling. After the milling the samples were still magnetic however the nanostructures of the carbon phase i.e. the carbon nanotubes were destroyed, as evidenced by the SEM images in FIG. 6. The ball milled sample was then acid-leached in 0.5 M H₂SO₄ solution at 85° C. for 9 hours. As the protecting layers of the structured carbon was removed, all the metal carbide was soluble during the acid leaching and the rest of the powder was not magnetic anymore (see FIG. 6). Accordingly the electrochemical activity of the sample was also gone. This example illustrated the significance of the catalyst structure.

In summary, a new class of ORR catalyst, i.e. self-assembled (hollow) spheres consisting of multiple and dispersed crystalline carbon-encapsulated metal carbide nanoparticles was synthesized by a facile one-step dry-autoclaving approach. This catalyst presented a unique structure of uniformly dispersed metal carbide nanoparticles within a structured carbon layers. The catalysts exhibited high activity and superior stability towards the ORR in acidic electrolytes compared with other non-precious metal catalysts. In alkaline solutions, its ORR activity and stability is comparable to that of the commercial Pt/C catalyst. In addition the catalysts possess excellent selectivity to a four-electron ORR process, with no activity for the methanol oxidation (which is a poison for ORR) and little intolerance to the phosphoric acid adsorption.

### FURTHER DETAILS OF THE INVENTION

The invention is described in further detail with reference to the following items:
1. A non-platinum metal material comprising a metal carbide particle and a carbon sphere, wherein the metal carbide particle is encapsulated inside of said carbon sphere, said carbon spheres consisting of graphene sheets and/or nanotubes
2. The material according to item 1, wherein the metal carbide particle is encapsulated by continuous or broken layers of graphene sheets and/or nanotubes.
3. The graphene sheets and/or carbon nanotubes according to any of the preceding items wherein said graphene sheets and/or carbon nanotubes are curved into microspheres.

1. A method of catalysis, comprising the steps of providing a non-platinum metal material comprising a metal carbide particle and a carbon sphere, wherein the metal carbide particle is encapsulated inside of said carbon sphere as defined in claim 7 as a catalyst.

2. The method according to claim 1, wherein the catalyst is used for oxygen redox reactions.

3. The method according to claim 1, wherein the catalyst is used for oxygen reduction reactions.

4. The method according to claim 1, wherein the catalyst is used as at least one of the electrodes for a fuel cell and/or an electrolyser comprising the non-platinum metal material.

5. The method according the claim 1, wherein the catalyst is used as a cathode of a fuel cell.

6. The method according to claim 1, wherein the catalyst is used as an anode of an electrolyser.

7. A non-platinum metal material comprising a metal carbide particle and carbon sphere, wherein the metal carbide particle is encapsulated inside of said carbon sphere, zo said carbon spheres comprising graphene sheets and/or nanotubes.

8. The material according to claim 7, wherein the carbon spheres consist of curved graphene sheets and/or nanotubes.

9. The material according to claim 7, wherein the graphene sheets and/or nanotubes form an unbroken layer around the metal carbide particle.

10. The material according to claim 8, wherein the graphene sheets and/or nanotubes form an unbroken layer around the metal carbide particle.

11. The material according to claim 7, comprising structured carbon wrapped metal carbide particles, where said wrapped metal carbides are further structured into a second spheric structure, wherein the carbide particles are uniformly dispersed, thereby forming a spheric cluster.

12. The material according to claim 11, wherein said second spheric structure is porous and optionally is hollow and optionally is in the micro range, preferably having a size in the sub micro range of smaller than 1000 nm.

13. The material according to claim 7, wherein the metal carbide particles are transition metal carbide particles, where the transition metal preferably is selected from the group consisting of iron, nickel, cobalt, chromium, titanium, copper and manganese.

14. The material according to claim 13, wherein the transition metal carbide particles are nanoparticles, preferably having a size in the range of 2-50 nm.

15. The material according to claim 7, wherein the carbon content lies in the range of 50-95 wt % and/or the metal content lies in the range of 5-50 wt %.

16. A method for preparing a non-platinum metal catalyst material, said method comprising the steps of:
(i) providing a carbon precursor,
(ii) providing a metal precursor,
(iii) introducing the carbon precursor and the metal precursor into an autoclave, and
(iv) dry-autoclaving the mixture of metal precursor and carbon precursor at high temperatures with auto-generated pressures under an inert atmosphere.

17. The method according to claim 16, wherein the carbon precursor is one or more heterocyclic molecules, preferably selected from the group consisting of cyanamide, cyanides, cyanuric acid, uric acid, imidazole, benzimidazole and amino-substituted triazines like ammeline, ammelide and melamine and/or wherein the metal precursor is one or more organometallic compounds, where the metal is preferably selected from the group consisting of iron, nickel, cobalt, chromium, titanium, copper and manganese.

18. The method according to claim 16, wherein the dry-autoclaving step proceeds at a temperature lying in the range of 500-1100° C. and optionally proceeds at a pressure from 200-800 bars.
